(19) United States
(12) Patent Application Publication
(10) Pub. No.: US 2003/0063863 A1
(43) Pub. Date: Apr. 3, 2003

(54) Multi-component board assembly

(76) Inventors: Bruno Nardelli, Watertown, MA (US); Mark Lucas, Chelmsford, MA (US); Jeffery V. Bean, Fitchburg, MA (US)

Correspondence Address: RAUSCHENBACH PATENT LAW GROUP, POST OFFICE BOX 387, BEDFORD, MA, 01730, US

(21) Appl. No.: 09/970,115

(22) Filed: Oct. 2, 2001

(51) Int. Cl. G02B 6/36; G02B 6/26

(52) U.S. Cl. 385/53; 385/15; 385/147

(57) ABSTRACT

An apparatus and method for assembling and interconnecting stacked optoelectronic circuit boards is described. The circuit boards are rotatably attached using a mechanism such as a hinge. Transmission lines such as optical fibers interconnecting the boards are guided parallel to or on the rotational axis of the attachment for a portion of their length. Bending stress on fiber optic interconnects due to relative motion of the circuit boards is minimized. Signals can be transmitted between the boards at any angle within a rotational range about the axis. This enhances access to components on stacked circuit boards and allows service procedures to be carried out efficiently.

### FIELD OF THE INVENTION

The present invention relates to multi-component board assembles. In particular, the present invention relates to multi-component board assembles that include optical components and to methods and apparatus for connecting electrical and optical components on a multi-board assembly.

### BACKGROUND OF THE INVENTION

Optical fiber communication systems are rapidly evolving to have extremely high bandwidth and flexible architectures. At the same time, optical fiber network providers are limiting the physical dimensions of the hardware and requiring a very high quality of service.

One way of reducing service costs and down time and thus increasing the quality of service is to design system components with relatively easy access to installed components. Such a design facilitates replacement, maintenance, or troubleshooting. Service time and maintenance costs can be significantly reduced by designing systems that allow access to components or boards without requiring the removal of boards from the communications system.

Known high-density electronic systems include interconnected circuit boards that are stacked in racks or other housings. Stacking the circuit boards saves space, but also restricts access to components mounted on interior-facing surfaces of the circuit boards. Circuit boards are often stacked by mounting one circuit board above one another using fixed mechanical standoffs.

Some electronic systems include interconnected circuit boards that are movable so as to allow easy access to components on the circuit boards. For example, some systems include mechanical slides that allow circuit boards to be pulled out of a rack to provide access to components. Other electronic systems include stacked circuit boards that are physically joined by a hinge that defines an axis about which a circuit board can be rotated to provide access to components.

Some known electronic equipment is designed so that two or more circuit boards can be moved relative to each other without having to electrically disconnect transmission lines that electrically couple the boards. This is accomplished by using flexible electrical transmission lines including cables or wire harnesses between circuit boards. The flexible electrical transmission lines enable signals to be exchanged between circuit boards during service procedures.

Transmission lines that interconnect circuit boards generally include one or more bends. When a circuit board is moved to perform a service procedure, the interconnecting transmission lines also move. The bend radius of a transmission line is typically changed by the sliding or flexion associated with moving circuit boards. This is especially true in tightly confined installations where large diameter service loops cannot be used. Electrical connections are relatively tolerant of small bend radii or repeated physical manipulation. However, fiber optic connections, as well as many fluid tubing connections, such as coolant or air pressure lines, are less tolerant of tight bends and handling.

### SUMMARY OF THE INVENTION

The present invention relates to methods and apparatus for interconnecting component boards with transmission lines. Transmission lines between component boards according to the present invention include fiber optic, electrical and fluid transmission lines. The transmission lines are physically flexible and allow signals to be transmitted between component boards over a range of relative rotational positions of the component boards.

Accordingly, the present invention features a multi-board assembly. The multi-board assembly includes two component boards that are rotatably attached along an axis. One or both of the component boards may be an electronic circuit board, an optical assembly, or an electro-optic component board. The axis may be positioned at an edge of one or both of the component boards, or may be displaced relative to an edge of one of the component boards.

One of the component boards has an angular rotation range about the axis relative to the other component board. The angular rotation range may be substantially from zero degrees to 360 degrees or may be smaller, for example, 180 degrees or 90 degrees. In one embodiment, the attachment between the component boards is a hinge. The hinge may define a conduit for passing one or more optical fibers.

In one embodiment, optical fibers propagate optical signals between the two component boards. At least one optical fiber has a bend radius that remains at a substantially fixed value relative to the component boards while the component boards are rotated to any angle within the angular rotation range. The optical fibers may be positioned substantially parallel to the axis, proximate to the axis, or substantially on the axis. The optical fibers may pass through a conduit that is positioned substantially parallel to the axis. In addition, the optical fiber may pass through a conduit defined by a hinge.

The multi-board assembly of the present invention also may include one or more electrical transmission lines, which are positioned substantially parallel to the axis, that propagate electrical signals between the component boards. In addition, the multi-board assembly of the present invention may include one or more conduits, which are positioned substantially parallel to the axis, that pass fluid between the component boards.

The present invention also features a method for optically coupling component boards. The method includes providing a first component board and rotatably attaching a second component board to the first component board. The second component board is attached to the first component board at a rotational axis that has an angular rotation range. The angular rotation range may be substantially from zero degrees to 360 degrees or may be smaller, for example, 180 degrees or 90 degrees.

In one embodiment, an optical fiber is positioned substantially parallel to the axis. In another embodiment, an optical fiber is positioned substantially proximate to or on the axis. One or more electrical transmission lines may also be positioned substantially parallel to the axis. In addition, one or more conduits for passing fluid may be positioned substantially parallel to the axis.

One end of the optical fiber is optically coupled to an optical component positioned on the first component board. A second end of the optical fiber is optically coupled to an optical component positioned on the second component board. The optical fiber has a bend radius that remains substantially at a fixed value relative to the component boards while the component boards are rotated to any angle within the angular rotation range. In one embodiment, at least one optical fiber propagates an optical signal from a component on one of the component boards to a component on the other component board. In one embodiment, a polarization state of the optical signal propagating through the optical fiber is substantially maintained at any angle within the angular rotation range.

The present invention also features a multi-board assembly that includes a first and a second component board. The second component board is rotatably attached to the first component board along an axis. The second component board has an angular rotation range about the axis. The multi-board assembly also includes at least one optical fiber having a bend radius that is substantially maintained at any angle within the angular rotation range. The at least one optical fiber propagates optical signals between the first component board and the second component board. In addition, the at least one optical fiber has a substantially constant birefringence at any angle within the angular rotation range.

### BRIEF DESCRIPTION OF THE DRAWINGS

This invention is described with particularity in the appended claims. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a schematic perspective drawing of a rotatably connected multi-board assembly according to the present invention.

FIG. 2 illustrates a schematic drawing of a rotatably connected multi-board assembly that includes an axial conduit through a hinge.

FIG. 3 illustrates a schematic side-view drawing of the rotatably connected multi-board assembly of FIG. 1 in an open position.

### DETAILED DESCRIPTION

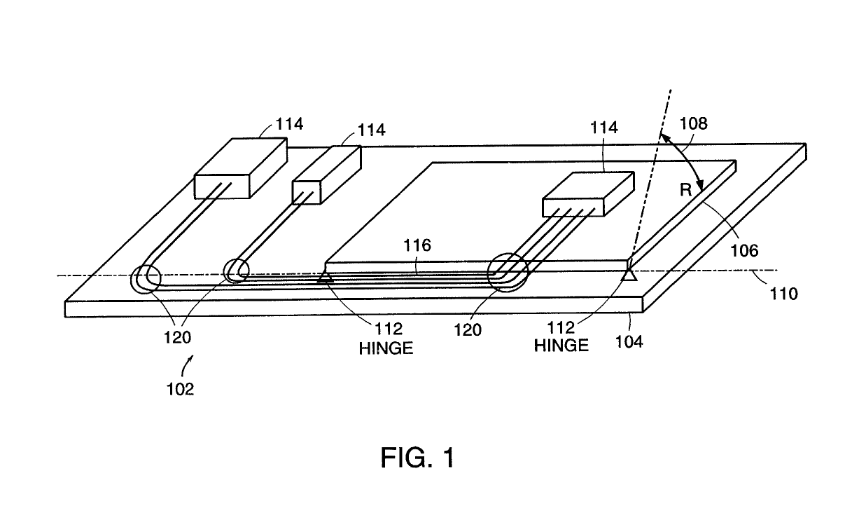

FIG. 1 illustrates a schematic perspective drawing of a rotatably connected multi-board assembly 102 according to the present invention. A first component board 104 and a second component board 106 are physically connected by a rotating mechanism that allows the second component board 106 to be rotated by an angle R 108 (a rotational angle) about an axis 110 with respect to the first component board 104. In FIG. 1, the rotational angle is equal to zero. In one embodiment, the rotating mechanism is at least one hinge 112.

The first 104 and the second component board 106 may include any number of components 114. The components 114 may be electronic, optical, mechanical, or fluid handling components or packages. Optical signals, electrical signals, electrical power, or fluids may be transmitted between the first 104 and the second component board 106 through one or more transmission lines 116.

In one embodiment, the transmission lines 116 are optical fibers. Optical fibers are used to transmit optical signals between the first 104 and the second component board 106. In another embodiment, the transmission lines 116 include both optical fibers and electrical wires (not shown). In another embodiment, the transmission lines include coolant tubing (not shown). In yet another embodiment, the transmission lines include compressed air lines (not shown).

The transmission lines 116 may include bends 120. The bends 120 may be required to connect the transmission lines 116 to components 114 on either or both of the first 104 and the second circuit board 106. The radius of the bends 120 is chosen to be above a minimum radius that preserves the transmission characteristics of the transmission lines 116. For example, the bend radius of an optical fiber must be maintained above a minimum value to preserve the transmission characteristics of the fiber. In addition, the bend radius of an optical fiber must be maintained above a minimum value to avoid the formation of micro-cracks that may result in a fracture through the optical fiber. The minimum safe bend radius for an optical fiber typically is about 2 inches.

Bending an optical fiber to a relatively small angle that does not risk the formation of micro-cracks can, however, induce birefringence in the optical fiber. Birefringence refers to differences in the optical transmission properties of an optical fiber, which are typically induced by stress that may be caused either intentionally or unintentionally. Birefringence can be caused by non-uniform stresses that destroy the cylindrical symmetry of the optical fiber. For example, as a bend radius of an optical fiber is changed, the propagation velocity of an optical signal having one polarization state within the optical fiber may change differently from the propagation velocity of an optical signal having an orthogonal polarization state within the optical fiber. The birefringence can change the polarization of the propagating signal, or may distort the optical signal in other ways. Many known optical fiber communication systems do not carefully control the positioning and winding of optical fibers and, therefore, bend-induced birefringence is common.

In one embodiment of the invention, the transmission lines 116 include a bend radius that is substantially maintained at a fixed value over a range of the rotational angle R (an angular rotation range). This can be achieved by positioning the transmission lines 116 substantially on the axis 110. The bend radius is maintained at a fixed value using one of several retaining methods that are known in the art. For example, the bend radius may be substantially fixed by placing the transmission lines 116 within a groove having a desired radius of curvature. Also, the bend radius may be substantially fixed by securing the transmission lines 116 to a desired bend using a series of clips attached to the first 104 or the second component board 106.

Guiding the transmission line on the axis 110, while substantially maintaining the bend radius, restricts the motion of the transmission line to a substantially torsional motion as the angle of rotation is changed. The transmission properties of optical fibers are generally more stable with torsional motion than they are with bending motion. Retaining the transmission lines 116 at the position of the bend 120 does not restrict torsional motion when the transmission lines are positioned on or proximate to the axis 110. Positioning the optical fiber parallel to the axis 110 reduces bending of the optical fiber relative to positions that are non-parallel to the axis 110.

In the multi-board assembly 102 shown schematically in FIG. 1, the axis 110 is positioned substantially at an edge of the second component board 106, and is displaced from an edge of the first component board 104. This physical arrangement restricts the angular range to substantially from zero degrees to 180 degrees. In another embodiment, the axis 110 is positioned substantially at an edge of each of the first 104 and the second component board 106. In this embodiment, the angular range is physically restricted to substantially from zero degrees to 360 degrees, which is a full rotation of the second board about the axis.

In another embodiment, the angular rotation range is restricted to substantially from zero degrees to 90 degrees. For example, the angular rotation range may be restricted to substantially from zero degrees to 90 degrees by the dimensions of an access panel in a chassis or rack in which the multi-board assembly is mounted. In one embodiment of the multi-board assembly of the present invention, the angular rotation range is not restricted by limitations in the torsional flexibility of the optical fiber transmitting optical signals between the first 104 and the second component board 106.

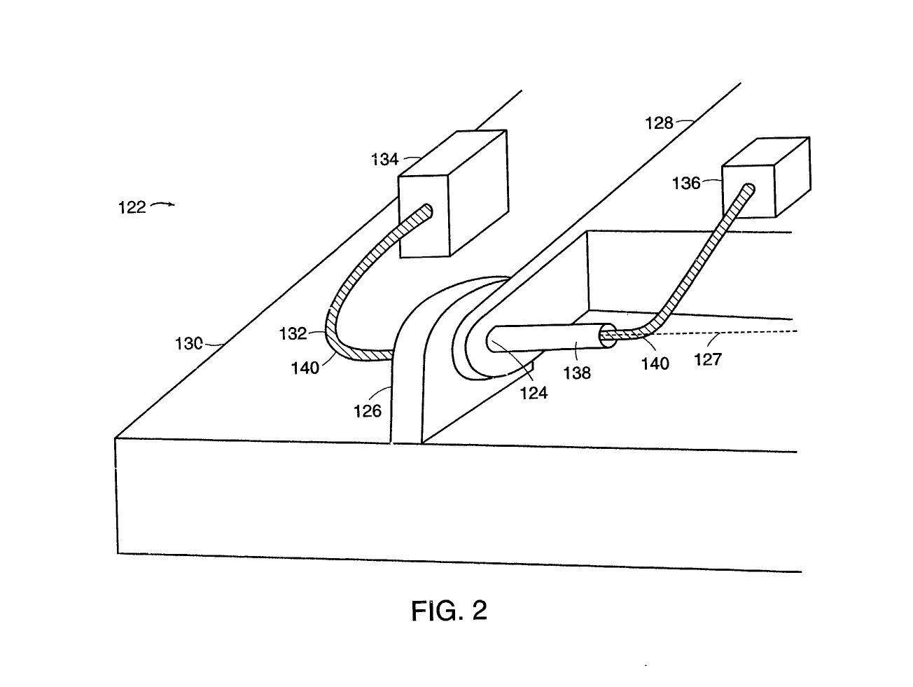

FIG. 2 illustrates a schematic drawing of a rotatably connected multi-board assembly 122 featuring a substantially axial conduit 124 through a hinge 126. The hinge has an axis 127 and an angular rotation range. A second component board 128 is attached to a first component board 130 by the hinge 126. Transmission lines 132 include at least one optical fiber that connects a first optical component 134 on the first component board 130 to a second optical component 136 on the second component board 128. The transmission lines 132 pass through the axial conduit 124. This positions the transmission lines 132 substantially on the axis 127 of the hinge 126. In one embodiment, a tube 138 extends axially beyond the hinge 126.

The radius of one or more bends 140 in the transmission lines 132 including the at least one optical fiber is maintained substantially fixed at any angle within the angular rotation range using fiber retention methods that are known in the art. In one embodiment, the transmission lines 132 include a plurality of optical fibers. In another embodiment, the transmission lines 132 also include one or more electrical transmission lines that transmit electrical signals or electrical power between the first 130 and the second 128 component board. In another embodiment, the transmission lines also include one or more conduits for passing a fluid between the first 130 and the second component board 128. In one embodiment, the fluid is a cooling fluid. In another embodiment, the fluid is a gas.

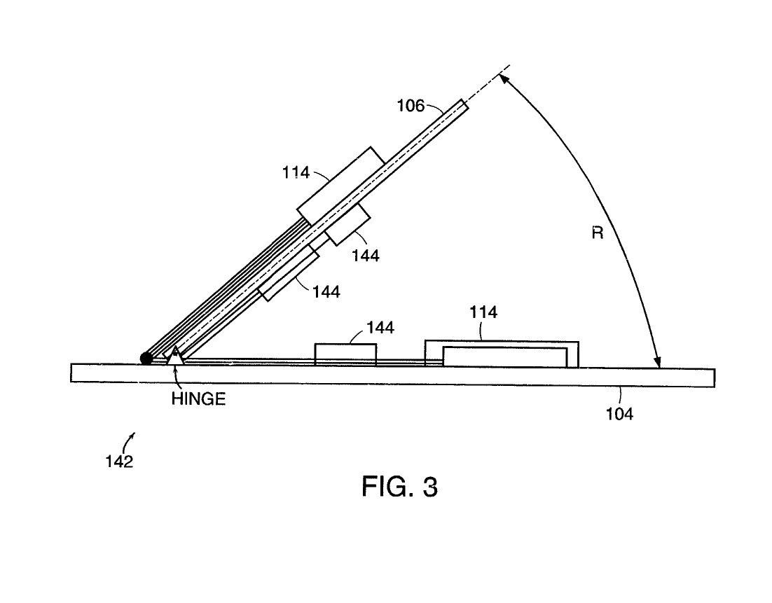

FIG. 3 illustrates a schematic side-view drawing of a hinged multi-board assembly 142 according to the present invention. The multi-board assembly 142 in FIG. 3 is similar to the assembly 102 in FIG. 1 except that the multi-board assembly 142 in FIG. 3 is shown in an open position where the angle of rotation, R, is approximately 45 degrees between the second component board 106 and the first component board 104. The open position of the multi-board assembly 142 shows how access is provided to components 144 that were hidden from view in the multi-board assembly 102 of FIG. 1.

Different values for the angular rotation range may be required for differently configured multi-board assemblies. An angular rotation range of 90 degrees provides access to most components on both component board surfaces that face each other when the angle of rotation is equal to zero. An angular rotation range of 180 degrees can provide clearer access to all sides of components on both component board surfaces that face each other when the angle of rotation is equal to zero. In addition, when the angle of rotation is equal to 180 degrees, components undergoing service operations can all be oriented in substantially a single plane. An angular rotational range of substantially a full rotation of 360 degrees allows for maximum access to either or both component boards. An angular rotation range of 360 degrees also allows the relative positions of the first or the second component board to be effectively reversed.

In one embodiment, signals can be transmitted between two rotatably attached component boards in a multi-board assembly with the component boards oriented at any angle within an angular rotational range. Service procedures can thus be performed efficiently, without disconnecting a transmission line or interrupting signal transmission between the component boards. Service procedures may include component and system testing, maintenance, repair, component replacement or other procedures.

A plurality of component boards can be rotatably attached using the present invention. In one embodiment, a plurality of component boards (daughter boards) is rotatably attached to a single component board (mother board) at a respective plurality of axes. The axes may be at an edge of the mother board or displaced from the edge. Fiber optic, electrical, and fluid connections may be made between any pair or pairs of the component boards. In another embodiment, a second component board is rotatably attached to a first component board, and a third component board is rotatably attached to the second component board. In yet another embodiment, a multi-hinge defines a single axis about which a plurality of component boards can rotate. Fiber optic, electrical, and fluid connections may be made between any pair or pairs of the component boards.

Equivalents

While the invention has been particularly shown and described with reference to specific preferred embodiments, it should be understood by those skilled in the art that various changes in form and detail may be made therein without departing from the spirit and scope of the invention as defined by the appended claims. For example, the invention can be practiced using any number of rotatably attached component boards. Component boards according to the present invention can also be physically interleaved or stacked using two or more rotational axes. In addition, the invention can be practiced for any type of optical fiber system.

What is claimed is:

1. A multi-board assembly comprising:
a) a first component board;
b) a second component board being rotatably attached to the first component board along an axis, the second component board having an angular rotation range about the axis; and
c) at least one optical fiber having a bend radius that is substantially maintained at any angle within the angular rotation range, the at least one optical fiber propagating optical signals between the first component board and the second component board.

2. The multi-board assembly of claim 1 wherein at least one of the first and the second component board comprises an electronic circuit board.

3. The multi-board assembly of claim 1 wherein at least one of the first and the second component board comprises an optical assembly.

4. The multi-board assembly of claim 1 wherein at least one of the first and the second component board comprises an electro-optic component board.

5. The multi-board assembly of claim 1 wherein the at least one optical fiber is positioned substantially parallel to the axis.

6. The multi-board assembly of claim 1 wherein the at least one optical fiber is positioned substantially on the axis.

7. The multi-board assembly of claim 1 wherein the at least one optical fiber is positioned substantially proximate to the axis.

8. The multi-board assembly of claim 1 wherein the second component board is rotatably attached to the first circuit board with a hinge.

9. The multi-board assembly of claim 8 wherein the hinge defines a conduit for passing the at least one optical fiber.

10. The multi-board assembly of claim 1 further comprising a conduit that is positioned substantially parallel to the axis, the conduit passing the at least one optical fiber.

11. The multi-board assembly of claim 1 further comprising a conduit that is positioned substantially parallel to the axis, the conduit passing fluid between the first component board and the second component board.

12. The multi-board assembly of claim 1 wherein the axis is positioned substantially at an edge of at least one of the first and the second component board.

13. The multi-board assembly of claim 1 wherein the axis is displaced in position relative to an edge of the first component board.

14. The multi-board assembly of claim 1 further comprising an electrical transmission line that is positioned substantially parallel to the axis, the electrical transmission line propagating electrical signals between the first component board and the second component board.

15. The multi-board assembly of claim 1 wherein the angular rotation range is substantially from zero degrees to 90 degrees.

16. The multi-board assembly of claim 1 wherein the angular rotation range is substantially from zero degrees to 180 degrees.

17. The multi-board assembly of claim 1 wherein the angular rotation range is substantially from zero degrees to 360 degrees.

18. A method for optically coupling component boards, the method comprising:
a) providing a first component board;
b) rotatably attaching a second component board to the first component board at a rotational axis, the rotational axis having an angular rotation range;
c) positioning an optical fiber substantially parallel to the axis; and
d) optically coupling a first end of the optical fiber to a component positioned on the first component board and optically coupling a second end of the optical fiber to a component positioned on the second component board, wherein
the optical fiber has a bend radius that is substantially maintained at any angle within the angular rotation range.

19. The method of claim 18 further comprising propagating an optical signal from a component on the first component board through the optical fiber to a component on the second component board.

20. The method of claim 19 wherein a polarization state of the optical signal propagating through the optical fiber is substantially maintained at any angle within the angular rotation range.

21. The method of claim 18 wherein the positioning of the optical fiber comprises positioning the optical fiber substantially along the axis.

22. The method of claim 18 wherein the positioning of the optical fiber comprises positioning the optical fiber substantially proximate to the axis.

23. The method of claim 18 further comprising positioning at least one electrical transmission line substantially parallel to the axis.

24. The method of claim 18 further comprising positioning at least one conduit for passing fluid substantially parallel to the axis.

25. The method of claim 18 wherein the angular rotation range is substantially from zero degrees to 90 degrees.

26. The method of claim 18 wherein the angular rotation range is substantially from zero degrees to 180 degrees.

27. The method of claim 18 wherein the angular rotation range is substantially from zero degrees to 360 degrees.

28. A multi-board assembly comprising:
a) a first component board;
b) a second component board being rotatably attached to the first component board along an axis, the second component board having an angular rotation range about the axis; and
c) at least one optical fiber having a bend radius that is substantially maintained at any angle within the angular rotation range, the at least one optical fiber propagating optical signals between the first component board and the second component board, wherein
the at least one optical fiber having substantially the same birefringence at any angle within the angular rotation range.
